(19) United States
(12) Patent Application Publication
(10) Pub. No.: US 2023/0373759 A1
(43) Pub. Date: Nov. 23, 2023

(54) Laminated Hook Including a Fastening System

(71) Applicant: Mazzella Lifting Technologies, Inc., Cleveland, OH (US)

(72) Inventors: Marc Nader, Cleveland, OH (US); Clyde Shetler, Cleveland, OH (US)

(73) Assignee: Mazzella Lifting Technologies, Inc., Cleveland, OH (US)

(21) Appl. No.: 18/319,217

(22) Filed: May 17, 2023

Related U.S. Application Data
(60) Provisional application No. 63/342,977, filed on May 17, 2022.

(51) Int. Cl. B66C 1/34

(52) U.S. Cl. CPC B66C 1/34

(57) ABSTRACT

The present disclosure relates to laminated hook including a fastening system. The hook is formed by a plurality of plates laminated together with a mechanical fastening system. The fastening system utilized to laminate the plates together to form the laminated hook includes a bolt and a nut. According to certain aspects of the present teaching, the nut is a barrel nut. According to further aspects of the present teaching, the hook is a laminated ladle hook. A process for forming a laminated hook is also provided.

### TECHNICAL FIELD

This present disclosure generally relates to a laminated hook, a method for forming a laminated hook and a fastening system for a laminated hook.

### BACKGROUND

Hooks are utilized in below-the-hook lifting device applications. A below-the-hook lifting device is a device used for attaching a load to a hoist. The device may contain components such as slings, hooks, and rigging hardware. A below-the-hook lifting device is a tool or mechanical device that attaches to a crane or other lifting apparatus, and grabs and secures a load so that it can be moved safely from one location to another.

There are many reasons why a below-the-hook lifting device is used. Safety and efficiency are the two main reasons for using a below-the-hook lifting device in conjunction with your crane and rigging equipment. In some applications, using a traditional wire rope sling, alloy chain sling, or synthetic sling just isn't enough to safely and securely move a load from one location to another. This is especially the case for lifting heavy and/or extremely hot materials. The present disclosure is directed to laminated hooks for general use and to laminated ladle hooks which are used for lifting hot metal ladles. Details for forming and using ladle hooks are provided in the document entitled, “Specifications For Ladle Hooks” (AISE Technical Report No. 7) published by the Association of Iron and Steel Engineers (May 1991), which is hereby incorporated by reference in its entirety. The laminated hooks disclosed herein represent an improvement to hooks including a plurality of plates that are laminated together through a hot riveting process. Hot rivetted hooks, as discussed in more detail below, subject the hook plates to thermal stress between heated and adjacent non-heated zones. This thermal stress results compromises the rivet engagement with the plates and results in a more loosened connection than what is desirable. In addition, the process of heating the rivets may result in damage to the metal of the rivet compromising the rivet's size and also resulting in a more loosened connection than desirable. The present disclosure provides a process for laminating hooks through a fastening system overcoming the deficiencies of the hot riveting lamination process discussed above and in greater detail below.

### SUMMARY

Provided is a laminated hook. The laminated hook includes: a plurality of plates, wherein each plate comprises a plurality of holes, wherein each plate has a profile of a hook, wherein the plurality of plates are aligned with each other, wherein the plurality of holes within the plurality of plates are aligned with each other, wherein the aligned holes between the plurality of plates form a set of aligned holes, and wherein the plurality of plates comprise a plurality of sets of aligned holes; at least one fastener set, wherein the fastener set includes: a nut; and, a bolt, wherein at least one set of the aligned holes between the plurality of plates are fitted with a nut and with a bolt to secure the plurality of plates together to form the laminated hook.

According to further aspects of the present teaching, the plurality of fastener sets include a barrel nut and bolt.

According to further aspects of the present teaching, the barrel nut includes a first end having a socket and a second end having a receiving portion for receiving the bolt and wherein the bolt includes a first end having a socket and a second end that is insertable within the receiving portion of the barrel nut.

According to further aspects of the present teaching, the receiving portion of the barrel nut and the insertable end of the bolt are fastened together with corresponding threads on the receiving portion of the barrel nut and the insertable end of the bolt.

According to further aspects of the present teaching, the socket on the first end of the barrel nut and the socket on the first end of the bolt is a hex socket.

According to further aspects of the present teaching, the outside surface of the barrel nut and the bolt are not ground.

According to further aspects of the present teaching, the barrel nut and bolt are manufactured from 1018 cold drawn steel bar.

According to further aspects of the present teaching, the barrel nut includes a barrel nut shaft and a barrel nut head, wherein the bolt includes a bolt shaft and a bolt head, wherein the barrel nut head is angled outwardly from the barrel nut shaft and wherein the bolt head is angled outwardly from the bolt shaft.

According to further aspects of the present teaching, the barrel nut and bolt have a tensile strength of 63,000 psi, a yield strength of 53,700 psi and a shear strength of 36,800 psi.

According to further aspects of the present teaching, the laminated hook includes an alternate screw body installation wherein the alternate screw body installation includes a first screw body installation wherein the barrel nut is inserted into a hole on a first side of the laminated plates and the bolt is inserted into the same hole on a second side of the laminated plates wherein the hole passes through the plurality of laminated plates and a second screw body installation wherein the bolt is inserted into an adjacent hole on the first side of the laminated plates and the barrel nut is inserted into the same adjacent hole on the second side of the laminated plates, wherein insertion of the barrel nuts and bolts into the plurality of holes in the laminated plates alternate in adjacent holes between the first screw body installation and the second screw body installation.

According to further aspects of the present teaching, the laminated hook includes four plates.

According to further aspects of the present teaching, the hook is a laminated ladle hook.

Also provided is a method for forming a laminated hook. The method includes the following steps: providing a plurality of plates, wherein each plate has a profile of a hook; aligning the plurality of plates with each other; clamping the plurality of aligned plates together; drilling at least one hole through the plurality of plates so that the holes are aligned with each other and so that the aligned holes between the plurality of plates form a set of aligned holes to provide a plurality of aligned plates comprising at least one set of aligned holes; providing at least one fastener set, wherein the fastener set includes: a nut; and, a bolt, fitting at least one set of the aligned holes between the plurality of plates with a nut and with a bolt; and fastening the nut and bolt together to secure the plurality of plates together to form the laminated hook.

According to further aspects of the present method, the at least one fastener set includes a barrel nut and bolt, wherein the barrel nut includes a first end having a socket and a second end having a receiving portion for receiving the bolt and wherein the bolt includes a first end having a socket and a second end that is insertable within the receiving portion of the barrel nut, wherein the receiving portion of the barrel nut and the insertable end of the bolt are fastened together with corresponding threads on the receiving portion of the barrel nut and the insertable end of the bolt, wherein the method includes rotating the barrel nut with respect to the bolt to fasten the barrel nut and bolt and the plurality of plates together.

According to further aspects of the present method, the socket on the first end of the barrel nut and the socket on the first end of the bolt is a hex socket, wherein the method further includes inserting a hex tool into the hex socket of the barrel nut and a hex tool into the hex socket of the bolt and rotating the barrel nut and the bolt with respect to each other to fasten the barrel nut and bolt and the plurality of plates together.

According to further aspects of the present method, the method includes installing a first barrel nut and a first bolt according to a first screw body installation, wherein the first screw body installation includes inserting the first barrel nut into a hole on a first side of the laminated plates and inserting the first bolt in the same hole on a second side of the laminated plates, wherein the hole passes through the plurality of laminated plates and installing a second barrel nut and a second bolt according to a second screw body installation, wherein the second screw body installation includes inserting a second bolt into an adjacent hole on the first side of the laminated plates and inserting a second barrel nut into the same adjacent hole on the second side of the laminated plates, wherein insertion of additional barrel nuts and bolts into a plurality of holes in the laminated plates alternate in adjacent holes between the first screw body installation and the second screw body installation.

According to further aspects of the present method, the at least one fastener set undergoes a cooling step prior to insertion within the aligned holes in the plates, wherein the cooling step includes one of the following: 1) cooling the at least one fastener set to a temperature of about −110° Fahrenheit in dry ice for one hour; or 2) cooling the at least one fastener set to a temperature of about −320° Fahrenheit in liquid nitrogen for one hour.

According to further aspects of the present method, the at least one fastener set is lubricated with a penetrating oil prior to insertion within the aligned holes in the plates.

According to further aspects of the present method, the barrel nut and bolt of the at least one fastener set is fastened at a torque of about 120 ft-lbs.

According to further aspects of the present method, after the at least one fastener set is torqued, the at least one fastener set is tack welded and a micro surface finish is applied to a fastened area on the surface on the first side and the second side of the laminated plates.

According to further aspects of the present method, the laminated hook includes four plates and wherein the laminated hook is a laminated ladle hook.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view of a riveted laminated hook.

FIG. 2 is a planar view of an exemplary nut according to some embodiments of the present disclosure.

FIG. 3 is a planar exploded view of an exemplary barrel nut and bolt according to some embodiments of the present disclosure.

FIG. 4A is a planar assembled view of an exemplary barrel nut and bolt according to some embodiments of the present disclosure.

FIG. 4B is a planar assembled view of an exemplary barrel nut and bolt according to some embodiments of the present disclosure.

FIG. 5 is a front perspective view of an exemplary laminated hook according to some embodiments of the present disclosure.

FIG. 6 is a front perspective view of an exemplary laminated hook according to some embodiments of the present disclosure.

FIG. 7 is a front perspective view of an exemplary laminated hook according to some embodiments of the present disclosure.

The present disclosure is to be considered as an exemplification of the invention and is not intended to limit the invention to the specific embodiments illustrated by the figures or description below.

### DETAILED DESCRIPTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless he context clearly indicates otherwise. It will be further understood that the terms “comprises” and/or “comprising,” when used in this specification, specify the presence of states features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interested in an idealized or overly formal sense unless expressly so defined herein. In the following description, for purposes of explanation, numerous specific details are set forth in order to provide a thorough understanding of the present invention. It will be evident, however, to one skilled in the art that the present invention may be practiced without these specific details.

Provided is a process for bolting a plurality of plates or hooks together to form a laminated hook (also referred to as a laminated plate or laminated hook plates). According to certain aspects of the present teaching, the laminated hook may be a laminated ladle hook. The process includes providing a set of metal bolting components that may be used in the process to secure the plates forming the laminated hook together.

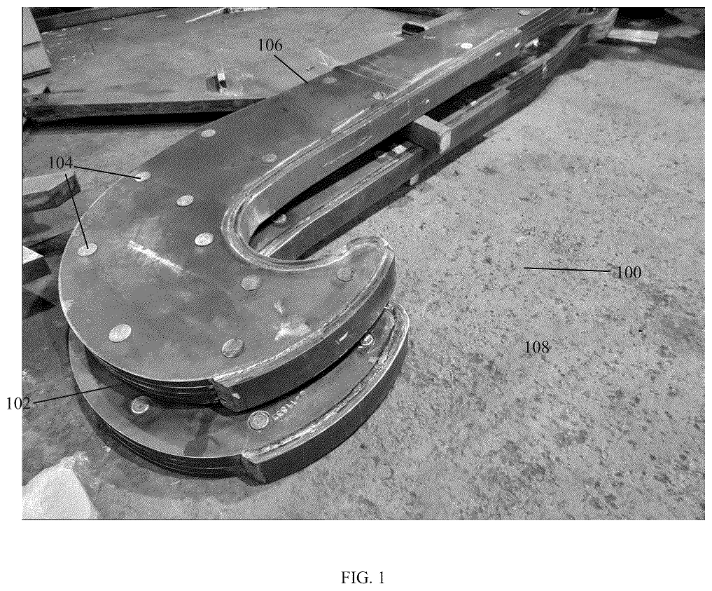

FIG. 1 illustrates a hook (100) including a set of plates (102) laminated together through a hot riveting process. As shown in FIG. 1, the hook (100) includes a plurality of rivets (104) to secure the plurality of plates together. The rivets (104) hold the laminations together to distribute load to all of the laminated plates (102) of the hook (100) so that each cross-section of the hook (100) and shank (106) work as an integrated section. The rivets (104) also ensure resistance to longitudinal resistance between the laminated plates (102) forming the hook (100). The most common practice in the art is to utilize hot rivets to secure the laminated plates together. The hot riveting process involves drilling holes in the plates to be laminated. The holes for the rivets shall be 1/16 inch greater in diameter than the normal diameter of the rivet. The rivet holes in the plurality of plates are aligned together by clamping the plates together and stack-drilling the hole. The stacked plates are then riveted while the plates are aligned and rigidly held together. In a hot driven riveting process, hot driven rivets are heated uniformly to a temperature not exceeding 1950° F. In this process, the hot rivets are not driven if the temperature of the rivets drips below 1000° F. Thus, driving hot rivets is an energy and labor intensive process. Typically, the rivets would be heated to 1,500° F. (red hot) with a well-constructed forge for proper temperature control. A baffle wall of fire resisting material would be placed in the furnace to direct the blast away from the rivets. The process for laminating the plates together may also involves using countersunk rivets. In this process, the head of the driven rivet fills a countersunk hole and is flush with or no higher than ⅛ inch above the surface of the outer lamination. Regardless, the use of hot rivets provides significant disadvantages. Laminated holes in the plates which receive hot metal rivets are subject to temperature gradients and over-stressing of rivets due to the junction between heated and adjacent non-heated zones in the plates. This thermal stress in the plates results in a loosened or compromised rivet engagement mechanism for securing the plates together. Moreover, the process of heating the rivets often results in exposing the rivets for too long of a period in the fire. This can be detrimental to the rivet material in that it causes the metal to waste away, thereby reducing the diameter of the rivet shank. This results in a less secure engagement between the plates because when such a rivet is installed, it does not fill the rivet hole completely and scale wedges between the plates and the rivet. Overall, the strength of the rivetted connection is considerably reduced.

The present disclosure remedies the disadvantages of rivetted plates by providing a hook wherein the plurality of plates are laminated with nuts and bolts rather than hot rivets and countersunk rivets. Bolted laminated hooks provide several advantages over hot riveted and countersunk riveted hooks. These advantages include the following. First, bolted, laminated hooks maintain from the point of manufacturing through use, a tighter compression of plates over hot rivets and countersunk rivets. Second, bolted hooks provide a bound fit to the holes drilled in the plates and prevent plate shifting that typically occurs in riveted hooks. Plate shifting is known to occur in riveted hooks due to rivets located near the load receiving the highest amount of shear loads. These rivets will become loose over time. The load will then be accommodated by the next rivets until they in turn become loose and the process continues. Third, bolted hooks are easier to repair as bolts can be easily replaced if broken or if found to be damaged or worn during routine maintenance inspections. For example, bolted fasteners may be checked by a maintenance crew and re-torqued if they become loose. This ensures that all the plates forming the hook remain tight and work as a unit, thereby providing a hook having a longer lifespan compared to riveted hooks. Fourth, bolted hooks hold up better to any type of side load compared to rivets. This is due to the holes and nuts and bolts providing a body bound fit and the plates being clamped together to form a tighter lamination. Fifth, bolted hook plates eliminate the need for welding. This allows the option to provide saddle and trunnion liners on the hook which are removeable rather than welded onto the hook.

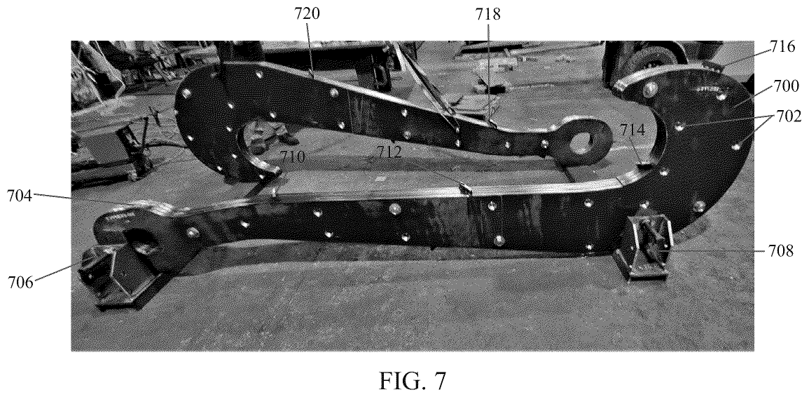

The present disclosure is directed to a set of metal bolting components and a plurality of plates that are secured together with the metal bolting components to form a laminated hook. The present disclosure is also directed to a process of bolting laminated plates of a hook or the like together to form a laminated hook. According to certain aspects of the present teaching the laminated hook is formed by securing a plurality of plates together. According to further aspects of the present teaching, the laminated hook is formed by securing at least two plates together. In further aspects of the present teaching, the laminated hook is formed by securing four plates together. In further aspects of the present teaching, the laminated hook is formed by securing two to four plates together. In further aspects of the present teaching, the laminated hook is formed by securing two or more plates together. FIG. 7 illustrates a step in the assembly of exemplary laminated hook (700). As shown in FIG. 7, the laminated hook (700) includes a plurality of holes (702) drilled through each of the plates (704). The process involves securing the plates (704) together with a clamp (706) at a first end of the hook and with a clamp (708) at a second end of the hook (700). The plates may also be secured by a clamps attached to a shank of the hook and to a bight of the hook. In FIG. 7, the plates are secured together by a first clamp (706) at a first end of the hook (700), a second clamp (708) at a second end of the hook (700), a first shank clamp (710) on the inside shank surface of the hook (700), a second shank clamp (712) on the inside shank surface of the hook (700), a bight clamp (714), a hook clamp (716) on the outside hook portion of the hook (700), a first shank clamp (718) on an outside shank surface of the hook (700), and a second shank clamp (720) on an outside shank surface of the hook (700). After securing the plates together with clamps, a plurality of holes are drilled through each of the plates. This allows the holes in each of the plates to be aligned with corresponding holes in the other plates forming the hook. In other embodiments, the plates may be pre-drilled or pre-formed with holes that correspond or match with holes in other plates forming the hook. Once clamped together, the plates are secured together with a plurality of bolts or bolts and nuts. As shown in FIG. 7, four plates are secured together with a set of five bolting components to form a laminated hook. According to certain aspects of the present teaching, additional bolting components may be inserted within at least some additional holes within the laminated plates of FIG. 7.

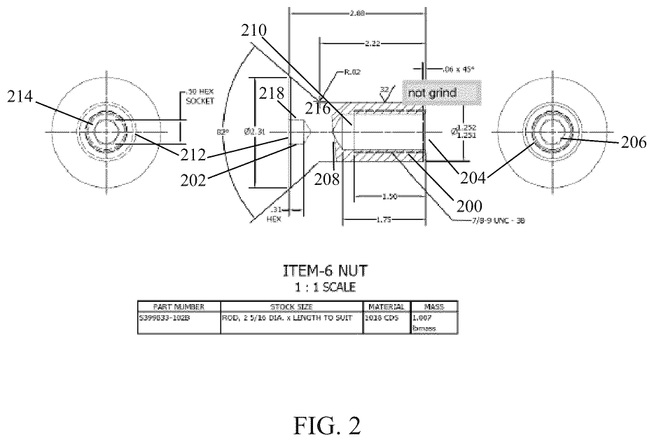

FIGS. 2, 3, 4A and 4B illustrate an exemplary barrel nut (200) and corresponding bolt (202) that may be used to secure the plurality of plates together to form a laminated hook. The barrel nut (200) of FIG. 2 includes a first end (204) having a socket (206) and a second end (208) having a receiving portion (210) for receiving a corresponding bolt (202). The bolt (202) includes a first end (212) having a socket (214) and a second end (216) having a shaft (218) that is insertable within the receiving portion (210) of the corresponding barrel nut (200). It is to be understood that the receiving portion (210) of the barrel nut (200) and the second insertable end (218) of the bolt each include a fastening mechanism (for example, corresponding threads), that allow the bolt to be fastened or secured to the barrel nut. The socket on the first end of the barrel nut and the socket on the second end of the barrel nut allows for insertion of a tool allowing the barrel nut to be tightened with respect to the bolt. According to certain aspects of the present teaching, the socket on the first end of the barrel nut and the socket on the first end of the bolt is a hex socket. This allows for insertion of a tool such as a hex key or a hex bit into the socket to allow the barrel nut and the bolt to be tightened with respect to each other through rotational force and movement of the bolt with respect to the barrel nut. According to certain aspects of the present teaching, the outside surface of the barrel nut and bolt are not ground. The barrel nut and bolt may be manufactured from 1018 cold drawn steel bar or another material deemed suitable by a person of ordinary skill in the art.

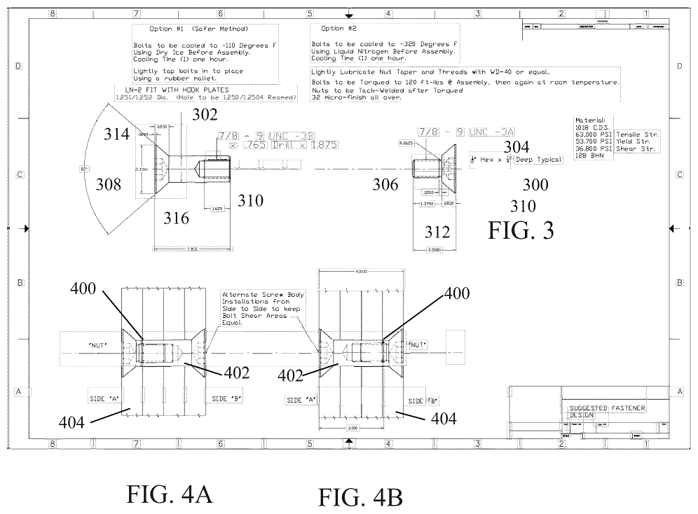

FIG. 3 illustrates a further embodiment of a barrel nut (300) and bolt (302) in a disassembled state. As in FIG. 2, the barrel nut (300) of FIG. 3 includes a first end having a socket (304) and a second end having a receiving portion (306) for receiving a corresponding bolt (302). The bolt (302) includes a first end having a socket (308) and a second end including a shaft (310) that is insertable within the receiving portion (306) of the corresponding barrel nut (300). The sockets referred to above may be positioned within a barrel nut head (312) and a bolt head (314). In the embodiments shown in FIG. 3, the barrel nut head (310) is angled outwardly from a barrel nut shaft (312) and the bolt head (314) is angled outwardly from a bolt shaft (316). It is to be understood that the receiving portion (306) of the barrel nut (300) and the second insertable end (310) of the bolt (302) each include a fastening mechanism (for example, corresponding threads), that allow the bolt (302) to be fastened or secured to the barrel nut (300). The socket on the first end of the barrel nut and the socket on the second end of the barrel nut allows for insertion of a tool allowing the barrel nut to be tightened with respect to the bolt. According to certain aspects of the present teaching, the socket on the first end of the barrel nut and the socket on the first end of the bolt is a hex socket. This allows for insertion of a tool such as a hex key or a hex bit into the socket to allow the barrel nut and the bolt to be tightened with respect to each other through rotational force and movement of the bolt with respect to the barrel nut. According to certain aspects of the present teaching, the outside surface of the barrel nut and bolt are not ground. The barrel nut and bolt may be manufactured from 1018 cold drawn steel bar or another material deemed suitable by a person of ordinary skill in the art. The barrel nut and bolt may have a tensile strength of 63,000 psi, a yield strength of 53,700 psi and a shear strength of 36,800 psi.

The barrel nut and bolt assembly provides an option for laminating the plurality of plates forming the hook together. Each hole within a first plate are aligned with corresponding holes in a plurality of corresponding plates forming the laminate hook. The plurality of plates are clamped together allowing the plates and holes within each of the plates to remain aligned. After aligning the holes in the plurality of plates together, a single barrel nut and bolt is inserted into each of the aligned holes between the clamped plates. The barrel nut and bolt are then torqued and fastened together with a tool (e.g., a hex key inserted into a hex socket in the barrel nut head and a hex socket in the bolt head) to secure and fasten the plates together to form the laminated hook.

According to certain aspects of the present teaching, the bolt and nut combination, including the barrel nut and bolt assembly, must undergo a cooling step prior to assembly into the holes of the plates forming the laminated hook. A first option for cooling the bolt and nut combination involves cooling the bolts and nuts to −110 or about −110 degrees Fahrenheit with dry ice for a period of one hour or about one hour prior to assembly within the plates. The bolts and barrel nuts may then be lightly tapped into the aligned holes in the plates to be laminated. According to certain aspects of the present teaching, this tapping may be accomplished with a tool for imparting force on another body such as a rubber or a wood mallet. A second option is to cool the bolt and nut combination to −320 or about −320 degrees Fahrenheit by exposing the bolt and nut combination to liquid nitrogen for a period of one hour or about one hour prior to assembly within the plates.

After the cooling step and prior to the insertion step into the holes of the plates, the bolt and nut combination, including the barrel nut and bolt combination undergoes a lubrication step. The lubrication step involves applying a lubricant to the threads of at least one of the bolt and nut combination. According to certain aspects of the present teaching, a lubricant is lightly applied to the threads of the barrel nut and/or bolt. According to further aspects of the present teaching, the lubricant may be applied to the nut taper and fastening threads of the bolt and nut combination with a penetrating oil such as WD-40 or an equivalent oil-based product.

After lubricating the bolt and nut combination, the nut and bolt combination are inserted into each of the aligned the holes of the plurality of plates and may be fastened together by rotationally torquing the nut and bolt combination with respect to each other.

According to certain aspects of the present teaching, the bolts in the bolt and nut combination are torqued to 120 ft-lbs or about 120 ft-lbs. Additional torque is applied to the bolt and nut combination when the bolt and nut combination achieves room temperature. After being torqued, the nuts are tack welded and a micro surface finish is applied to the bolted areas of the two outer plates at the two outer ends of the laminated hook. According to certain aspects of the present disclosure, a 32 surface finish is applied meaning that the surface of the plate has a roughness of 32 microns, equivalent to 1/32 inch.

FIGS. 4A and 4B illustrate a barrel nut (400) and bolt (402) in an assembled state with FIG. 4A illustrating the barrel nut (400) and bolt (402) fastened together from their respective sides and FIG. 4B illustrating the barrel nut (400) and bolt (402) fastened together from opposing sides. More specifically, FIG. 4A illustrates a barrel nut (400) on side A engaged to a bolt (402) on side B and FIG. 4B illustrates a barrel nut (400) on side B engaged to a barrel nut (402) on side A. According to certain aspects of the present disclosure side A represents a first side of laminated plates (404) and side B represents a second side of laminated plates (404). The laminated plates (404) may form a hook or similar load bearing mechanical device. According to further aspects of the present teaching, FIG. 4A illustrates a first screw body installation wherein the barrel nut (400) is inserted into a hole on side A that passes through the laminated plates (404) and the bolt (402) is inserted into a corresponding hole on side B that passes through the laminated plates (404). FIG. 4B illustrates a second screw body installation wherein the bolt (402) is inserted into a hole on side A that passes through the laminated plates (404) and the barrel nut (400) is inserted into a corresponding hole on side B that passes through the laminated plates. The embodiments illustrated in FIGS. 4A and 4B include four laminated plates (404). However, it is to be understood that any number of laminated plates may be utilized as deemed suitable by a person of ordinary skill in the art. According to further aspects of the present teaching, the plurality of holes within the plates are alternately fitted with a barrel nut and bolt according to a first screw body installation and a second screw body installation wherein barrel nuts are alternately fitted within holes on side A and within holes on side B of the laminated plates and bolts are alternately fitted within holes on side A and within holes on side B of the laminated plates. This alternate screw body installation from side to side allows for bolt shear areas to be kept equal.

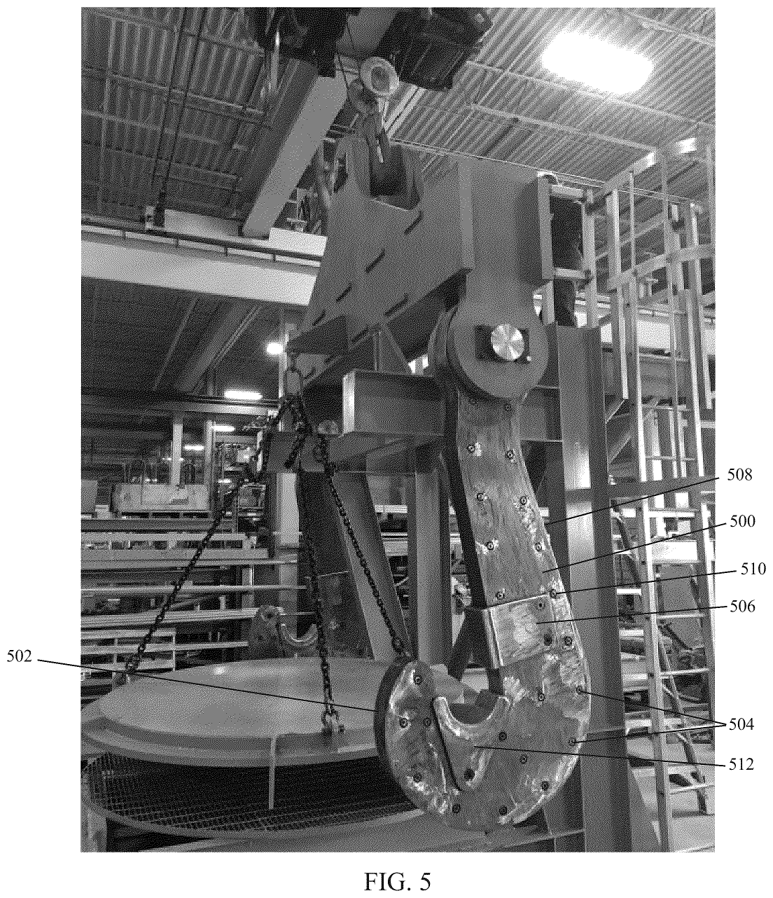

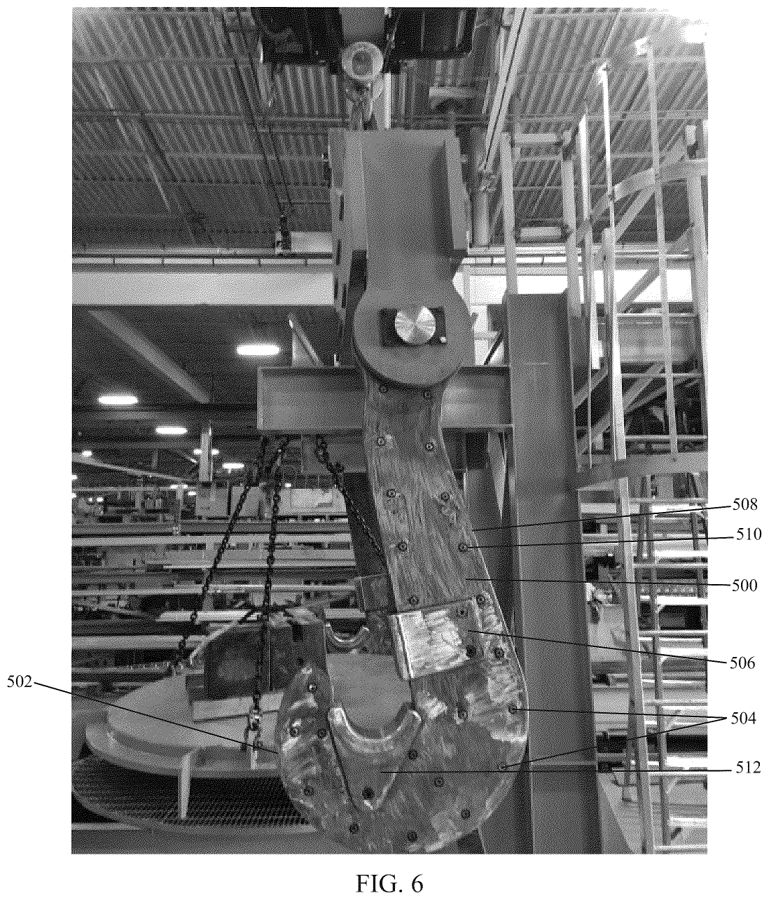

FIGS. 5 and 6 illustrate an exemplary laminated hook (500) comprising a plurality of plates (502) secured together with a nut and bolt assembly (504), in particular a barrel nut and bolt combination according to an alternate screw body installation, i.e., a first body screw installation and a second body screw installation. The laminated hook (500) may include a clamp (506) installed along the shank (508) to provide further stability and structural support to the laminated plates (502). The clamp (506) may also be designed as a protective plate against wear of the shank (508) while carrying various loads. The clamp (506) may be installed with a barrel nut and bolt assembly (504) fitted into the corresponding holes (510) of the plates (502). Alternatively, the clamp may installed with a general nut and bolt combination fitted into the corresponding holes of the plates. The laminated hook (500) may also include a wearing plate (512) fitted onto the inner surface of the hook between the outside tip of the hook and the ladle trunnion of the hook. The wearing plate (512) may also be referred to as a trunnion seat wearing plate. According to further aspects of the present teaching, the trunnion seat wearing plate may be installed with a barrel nut and bolt assembly (504) fitted into the corresponding holes (510) of the plates (502). Alternatively, the trunnion seat wearing plate may installed with a general nut and bolt combination fitted into the corresponding holes of the plates. The laminated hook (500) may also include an edge surface wearing plate (shown as 108 in FIG. 1). The edge surface wearing plate may be fitted along one or more of an outer bottom curved portion of the hook portion of the laminated hook, the inner curved portion of the hook portion of the laminated hook, the outer edge portion of the shank and the inner edge portion of the shank. The edge surface wearing plate may be installed with a barrel nut and bolt assembly (504) fitted into the corresponding holes (510) of the plates (502). Alternatively, the outside hook surface wearing plate may be installed with a general nut and bolt combination fitted into the corresponding holes of the plates. It is to be understood that the clamp and wearing plate accessories described above may be installed with barrel nuts and bolts through the laminate plate holes utilizing the alternate screw body installation method as described above.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof. Further, the “invention” as that term is used in this document is what is claimed in the claims of this document. The right to claim elements and/or sub-combinations that are disclosed herein as other inventions in other patent documents is hereby unconditionally reserved.

Having thus described the invention, it is now claimed:

What is claimed is:

1. A laminated hook comprising:
a plurality of plates, wherein each plate comprises a plurality of holes, wherein each plate has a profile of a hook, wherein the plurality of plates are aligned with each other, wherein the plurality of holes within the plurality of plates are aligned with each other, wherein the aligned holes between the plurality of plates form a set of aligned holes, and wherein the plurality of plates comprise a plurality of sets of aligned holes;
at least one fastener set, wherein the fastener set comprises:
a nut; and,
a bolt
wherein at least one set of the aligned holes between the plurality of plates are fitted with a nut and with a bolt to secure the plurality of plates together to form the laminated hook.

2. The laminated hook of claim 1, wherein the plurality of fastener sets comprises a barrel nut and bolt.

3. The laminated hook of claim 2, wherein the barrel nut comprises a first end having a socket and a second end having a receiving portion for receiving the bolt and wherein the bolt comprises a first end having a socket and a second end that is insertable within the receiving portion of the barrel nut.

4. The laminated hook of claim 3, wherein the receiving portion of the barrel nut and the insertable end of the bolt are fastened together with corresponding threads on the receiving portion of the barrel nut and the insertable end of the bolt.

5. The laminated hook of claim 4, wherein the socket on the first end of the barrel nut and the socket on the first end of the bolt is a hex socket.

6. The laminated hook of claim 5, wherein the outside surface of the barrel nut and the bolt are not ground.

7. The laminated hook of claim 6, wherein the barrel nut and bolt are manufactured from 1018 cold drawn steel bar.

8. The laminated hook of claim 7, wherein the barrel nut comprises a barrel nut shaft and a barrel nut head, wherein the bolt comprises a bolt shaft and a bolt head, wherein the barrel nut head is angled outwardly from the barrel nut shaft and wherein the bolt head is angled outwardly from the bolt shaft.

9. The laminated hook of claim 8, wherein the barrel nut and bolt have a tensile strength of 63,000 psi, a yield strength of 53,700 psi and a shear strength of 36,800 psi.

10. The laminated hook of claim 9, wherein the laminated hook comprises an alternate screw body installation wherein the alternate screw body installation comprises a first screw body installation wherein the barrel nut is inserted into a hole on a first side of the laminated plates and the bolt is inserted into the same hole on a second side of the laminated plates wherein the hole passes through the plurality of laminated plates and a second screw body installation wherein the bolt is inserted into an adjacent hole on the first side of the laminated plates and the barrel nut is inserted into the same adjacent hole on the second side of the laminated plates, wherein insertion of the barrel nuts and bolts into the plurality of holes in the laminated plates alternate in adjacent holes between the first screw body installation and the second screw body installation.

11. The laminated hook of claim 1, comprising four plates.

12. The laminated hook of claim 1, wherein the hook is a laminated ladle hook.

13. A method for forming a laminated hook comprising the following steps:
providing a plurality of plates, wherein each plate has a profile of a hook;
aligning the plurality of plates with each other;
clamping the plurality of aligned plates together;
drilling at least one hole through the plurality of plates so that the holes are aligned with each other and so that the aligned holes between the plurality of plates form a set of aligned holes to provide a plurality of aligned plates comprising at least one set of aligned holes;
providing at least one fastener set, wherein the fastener set comprises:
a nut; and,
a bolt,
fitting at least one set of the aligned holes between the plurality of plates with a nut and with a bolt and
fastening the nut and bolt together to secure the plurality of plates together to form the laminated hook.

14. The method of claim 13, wherein the at least one fastener set comprises a barrel nut and bolt, wherein the barrel nut comprises a first end having a socket and a second end having a receiving portion for receiving the bolt and wherein the bolt comprises a first end having a socket and a second end that is insertable within the receiving portion of the barrel nut, wherein the receiving portion of the barrel nut and the insertable end of the bolt are fastened together with corresponding threads on the receiving portion of the barrel nut and the insertable end of the bolt, wherein the method comprises rotating the barrel nut with respect to the bolt to fasten the barrel nut and bolt and the plurality of plates together.

15. The method of claim 14, wherein the socket on the first end of the barrel nut and the socket on the first end of the bolt is a hex socket, wherein the method further comprises inserting a hex tool into the hex socket of the barrel nut and a hex tool into the hex socket of the bolt and rotating the barrel nut and the bolt with respect to each other to fasten the barrel nut and bolt and the plurality of plates together.

16. The method of claim 15 further comprising installing a first barrel nut and a first bolt according to a first screw body installation, wherein the first screw body installation comprises inserting the first barrel nut into a hole on a first side of the laminated plates and inserting the first bolt in the same hole on a second side of the laminated plates, wherein the hole passes through the plurality of laminated plates and installing a second barrel nut and a second bolt according to a second screw body installation, wherein the second screw body installation comprises inserting a second bolt into an adjacent hole on the first side of the laminated plates and inserting a second barrel nut into the same adjacent hole on the second side of the laminated plates, wherein insertion of additional barrel nuts and bolts into a plurality of holes in the laminated plates alternate in adjacent holes between the first screw body installation and the second screw body installation.

17. The method of claim 16, wherein the at least one fastener set undergoes a cooling step prior to insertion within the aligned holes in the plates, wherein the cooling step comprises one of the following: 1) cooling the at least one fastener set to a temperature of about −110° Fahrenheit in dry ice for one hour; or 2) cooling the at least one fastener set to a temperature of about −320° Fahrenheit in liquid nitrogen for one hour.

18. The method of claim 17, wherein the at least one fastener set is lubricated with a penetrating oil prior to insertion within the aligned holes in the plates.

19. The method of claim 18, wherein the barrel nut and bolt of the at least one fastener set is fastened at a torque of about 120 ft-lbs.

20. The method of claim 19, wherein after the at least one fastener set is torqued, the at least one fastener set is tack welded and a micro surface finish is applied to a fastened area on the surface on the first side and the second side of the laminated plates.

21. The method of claim 20, wherein the laminated hook comprises four plates and wherein the laminated hook is a laminated ladle hook.
